(19) United States
(12) Patent Application Publication
(10) Pub. No.: US 2021/0279360 A1
(43) Pub. Date: Sep. 9, 2021

(54) TRACKERS OF CONSENTED DATA TRANSACTIONS WITH CUSTOMER-CONSENT DATA RECORDS

(71) Applicant: Hewlett-Packard Development Company, L.P., Spring, TX (US)

(72) Inventors: Galo Gimenez Palop, Boise, ID (US); Christopher Douglas, Ft. Collins, CO (US); Shane I. Saunders, Ft. Collins, CO (US)

(73) Assignee: Hewlett-Packard Development Company, L.P., Spring, TX (US)

(21) Appl. No.: 16/627,410

(22) PCT Filed: Oct. 24, 2017
(86) PCT No.: PCT/US2017/058027

§ 371 Date: Dec. 30, 2019

(51) Int. Cl. G06F 21/62; G06F 21/60

(52) U.S. Cl. CPC G06F 21/6245; G06F 21/604

(57) ABSTRACT

Disclosed herein is a consent management (CM) technology that facilitates the tracking of consented data transactions with customer-consent data records by an agency. A consented data transaction includes an action requested to or actually performed on or with a customer-consent data record of a particular customer of the agency. The customer-consent data record contains sensitive personal information (SPI) of and/or about the particular customer. With this technology, the agency's CM system may provide evidence of all consented data transactions with the customer-consent data record to, for example, government regulators and to the customer herself.

### BACKGROUND

Consent management is a term used to describe systems, processes or sets of policies that enable a customer to determine what personal information of and about the customer of an agency that the agency maintains. Consent management also describes how the agency is permitted to use and share that personal information.

More particularly, the customer's personal information that the agency manages is personally identifiable information (PII), which is also called sensitive personal information (SPI). Such information is the kind that can be used—on its own or with other information—to identify, contact, or locate the customer.

### BRIEF DESCRIPTION OF THE DRAWINGS

FIG. 1 illustrates an example scenario 100 that includes example systems and components in accordance with the technology described herein.

FIGS. 2-4 are flowcharts illustrating example methods in accordance with the technology described herein.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Disclosed herein is a consent management (CM) technology that facilitates the tracking of consented data transactions with customer-consent data records by an agency. A consented data transaction includes an authorized action performed on or with a customer-consent data record of a particular customer of the agency. The customer-consent data record contains sensitive personal information (SPI) of and/or about the particular customer. With this technology, the agency's CM system may provide evidence of all consented data transactions with the customer-consent data record to, for example, government regulators and to the customer herself.

Using this technology, an agency's CM system may obtain a request from a requestor to perform some consented data transaction with the customer-consent data record of a particular customer. For example, a marketing department of a company may wish to send a promotional offer to a homeowner via the home owner's mobile phone using the short-message service (SMS). To sending the promotional offer to the homeowner, the marketing service of the company confirms that the homeowner has consented to this type of communication for such purposes.

A requestor may be, for example, internal or external. An internal requestor may be some portion or part of the agency. Examples of an internal requestor include other online services of the agency, other departments of the agency, and consultants or other parties working for or with the agency. An external requestor is one that is outside of or separate from the agency. Examples of external requestor include a government compliance officer or a court-appointed official.

After validating that the requested data transaction is permitted, the CM system may grant the consented data transaction of the customer-consent data record to the requestor. Using this technology, the CM system may track the consented data transaction by the requestor of the customer-consent data record. Examples of such consented data transactions include requests to use, grants of use, and actual use of some portion of the customer-consent data record. The CM system stores the tracked consented data transactions in a searchable and/or indexed audit log or trail that is associated with the particular customer.

As a result, the audit trail may be searched to find the consented data transactions of the customer-consent data record. In addition, the CM system may use this audit trail to track and store any changes to the customer-consent data record, including changes in consent itself.

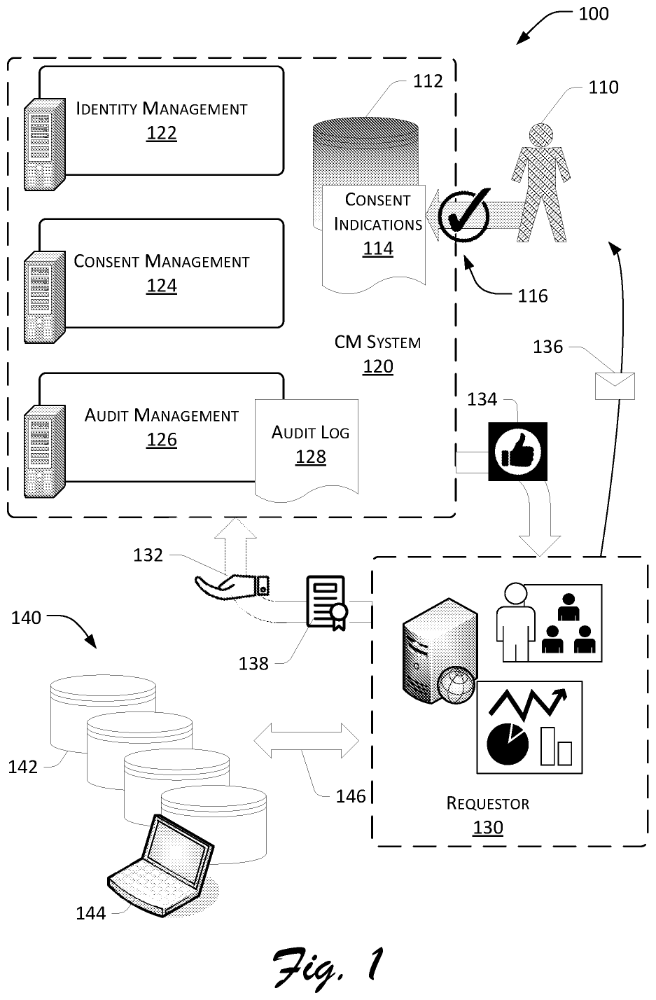

FIG. 1 illustrates an example scenario 100 that includes example systems and components in accordance with the technology described herein. As depicted, FIG. 1 includes a customer 110, a consent management system 120, a requestor 130 and one or more data sources 140.

The consent management (CM) system 120 includes the main components: identity management 122, consent management 124, and audit management 126. As depicted, each component of the CM system 120 is implemented on different computers that are working in cooperation. In other instances, these components may function as different programs, services, or applications operating on common or different computing systems or platforms.

As depicted, the CM system 120 is part of or is controlled by an agency for which the customer 110 is a user or patron thereof. In other instances, components of the CM system 120 may be owned or controlled by different agencies and entities. For example, a government authority may offer the identity management 122. The agency may be, for example, business, an organization, an institution, an online service, a service provider, a company, or the like.

As depicted, the customer 110 is a person who has a business or some form of relationship with the agency that operates or controls the CM system 120. The customer need not literally be a customer of the agency. Rather, as used herein, a customer may be, for example, a user, consumer, client, patron, employee, contractor, shopper, subscriber, purchaser, prospect, person, or the like of the agency.

The consent management 124 maintains a customer-consent data record 112 for the customer 110 and for each of its customers. The customer-consent data record 112 may be stored, for example, with or at one of the data sources 140, the CM system 120, with the customer 110, and/or at the requestor 130.

The consent management 124 obtains the explicit or implicit consent 116 from the customer 110 for the permissible use of the information in the customer's customer-consent data record 112. The consent indications 114 include a record of the customer's consent 116 (or lack thereof) for the associated information in the customer-consent data record 112. That is, the consent indications 114 indicates the usages of the customer-consent data record that are designated permissible or impermissible. The permissibly may be designated by the customer. The customer-consent data record 112 is associated with the customer 110 and one or more consent indications 114 that indicate a usage of the information of the customer-consent data record that is permissible by the customer.

The customer-consent data record 112 includes sensitive personal information (SPI) that can be used to identify, contact, or locate the customer 110. Examples of the type of SPI that may be part of customer-consent data record 112 includes full name, home address, mailing address, billing address, shipping address, email address, identification number, account identifier, passport number, driver's license number, Internet Protocol (IP) number, vehicle registration number, image of face, description of facial features, image of fingerprint, image of handwriting, image of signature, credit card numbers, bank account numbers, digital identity, date of birth, birthplace, genetic information, medical data, telephone number, login or username, gender, race, ethnicity, age, criminal record, online cookie information, web browsing history, place of residence, citizenship, legal status, marital status, social security number, religious preference, sexual orientation, security clearance, mother's maiden name, military records, disability information, biometrics, employment information and history, and some combination thereof.

A requestor 130 seeks to use the information in the customer-consent data record 112. The requestor 130 may be, for example, a computing system, a service, application, a department, a portion thereof, or a combination thereof. As depicted, the requestor 130 is a data service of the marketing department of the agency.

In the example scenario 100, the marketing department is preparing to send out its most recent promotional offers to the existing customers of the agency. In preparation for that, the marketing department—acting as the requestor 130—seeks to obtain access to the mobile telephone number of the customer 110 and seeks permission to use that number to send the promotional offer.

To accomplish this, the requestor 130 sends a request 132 to perform a data transaction with the customer-consent data record 112. A data transaction includes an action performed with a customer-consent data record of a particular customer of the agency. In another way, a data transaction may be described as a use of a customer-consent data record of a particular customer of the agency. Examples of a consented or granted data transaction performed with the customer-consent data record includes reading, copying, viewing, editing, analyzing, writing, modifying, accessing, sharing, accessing for advertising purposes, accessing for marketing purposes, accessing to facilitate generating a customized experience for the particular customer, accessing for product or service feedback or surveys, accessing for improving customer service, accessing to reduce risk of fraud, gathering metrics, and some combination thereof.

In this example, the particular information of interest of the customer-consent data record 112 is the mobile telephone number of the customer 110. The purpose of the request 132 is to use the mobile telephone number. More particularly, the purpose of the request 132 is to have access to the mobile telephone number and to send an SMS message to the customer using that number. The customer's mobile telephone number may be stored, for example, at or with one of the data sources 140, the CM system 120, the customer-consent data record 112, the customer 110, or the requestor 130.

In some instances, the identity management 122 may confirm the identity of the requestor 130 as being an entity that is authorized to make such requests. This assures that only authorized entities may access or use the information in the customer-consent data record 112.

In response to obtaining the request 132 from the requestor, the consent management 124 determines whether the request is for a data transaction with the customer-consent data record is permissible based on the associated one or more consent indications 114. For example, if the consent indications 114 show that the customer 110 consents to receiving promotional offers via SMS messages, then the consent management 124 may validate the request 132.

Once the request is validated, the consent management 124 grants the requested data transaction with the customer-consent data record to the requestor 130. As depicted, the consent management 124 sends a grant 134 to the requestor 130. In some instances, the grant 134 includes a unique identifier (i.e., grant ID) to the requestor 130. Subsequently, the grant ID along associated with any consented data transaction taken by the requestor 130.

In response to the granted request, the audit management 126 tracks the granted request for data transaction with the customer-consent data record to the requestor 130. The audit management 126 stores a record of the request and/or grant in an audit log 128 (i.e., audit trail). More particularly, these entries in the audit log 128 are associated with the coordinating and/or relevant consent indications 114. For example, the audit log 128 stores a record of the granted data transaction, the grant ID, and the permission to send promotional SMS messages to the customer in association with each other.

As depicted, the requestor 130 sends an SMS message 136 with a promotional offer to the customer 110 via the acquired mobile telephone number of the customer. In conjunction with that data transaction, the requestor 130 sends an execution indication 138 that indicates that the requestor performed the granted data transaction with the customer-consent data record in accordance with the grant 134. The execution indication 138 may include, for example, a copy of the grant ID to positively and uniquely identify the particular grant 134 that authorized the requestor's data transactions.

In response to the receiving the execution indication 138, the audit management 126 stores a record of the granted data transaction actually being performed in the audit log 128. More particularly, the granted-action entry in the audit log 128 is associated with the coordinating and/or relevant consent indications 114. For example, the audit log 128 stores a record of the execution indication 138, the grant ID, and the permission to send promotional SMS messages to the customer in association with each other.

The data sources 140 represents a logical or physical location where some portion of the requested and/or consented data transaction is performed or is the target of such data transaction. For example, the data sources 140 may store a portion of the customer-consent data record. The data sources 140 may, for example, store data that is the target of the data transaction that the requestor 130 seeks to perform. Consequently, double-headed arrow 146 represents the flow a data back and forth between the data sources and the requestor.

The data sources 140 includes the example storage 142 and example computer 144. The example storage 142 may be a primary or secondary storage unit, such as a computer-readable media. The example storage 142 may be centralized or distributed. The example storage 142 may be, for example, part of the CM system 120 or part of other systems. The example computer 144 may be, for example, the computer system of another agency, part of the same agency, a customer, or the customer 110.

With reference to the example scenario 100, the requestor 130 may, for example, seek to acquire performance and error metrics from the example computer 144, which may be owed by the customer 110. Thus, after the CM system 120 validates the requestor's request to access these metrics, the requestor 130 can upload the metrics from the customer's computer.

The audit log 128 includes a set of indexed and/or searchable data record containing a history of data transactions with the customer-consent data record based on consent indications 114. Since the audit logs 128 contains the history of requested and granted data transactions relative to the customer-consent data records, the absence of particular entries indicates that the data transaction s of those particular entries did not occur. To promote this evidentiary basis, the audit logs 128 may be encoded and/or encrypted in a manner that leaves evidence of modifications. Some version of blockchain technology may be used to implement this.

To promote transparency of the agency's handling of the customer's SPI to the customer 110, the agency may allow the customer to access the customer-consent data record 112 and/or the associated consent indications 114. For example, the agency may allow the customer 110 to view and change the information in the customer-consent data record 112 and the associated consents.

With reference to the example scenario 100, the consent management 124 may receive a request from the customer 110 to access or change the customer-consent data record 112 associated with the customer. Based at least in part on an identification performed by the identity management 122, the consent management 124 may grant the requested access or change of the customer-consent data record to the customer 110. The audit management 126 tracks that grant and the actual access or change. The audit management 126 stores a record of tracked grant and actual access or change in the audit log 128, which is associated with the customer 110.

To further promote transparency of the agency's handling of the customer's SPI to a relevant requesting party, the agency may allow the viewing of the customer-consent data record 112, the associated consent indications 114, and/or the audit logs 128. A relevant requesting party may be, for example, the customer 110, an intragency compliance authority, the requestor 130, and/or an external third-party with proper authorization to view such records. The external third-party may be, for example, a government compliance officer, a court-appointed officer, or the like. For example, the agency may allow a privacy-compliance officer to view the audit logs 128 to confirm the proper handling of the customer's SPI.

With reference to the example scenario 100, the audit management 126 may receive a request from a requesting party to access the audit log associated with the customer 110. After a validation that the requested access to the audit log is permissible by the requesting party, the audit management 126 may grant the requested access to the audit log to the requesting party and, thus, provide access to the audit log to the requesting party.

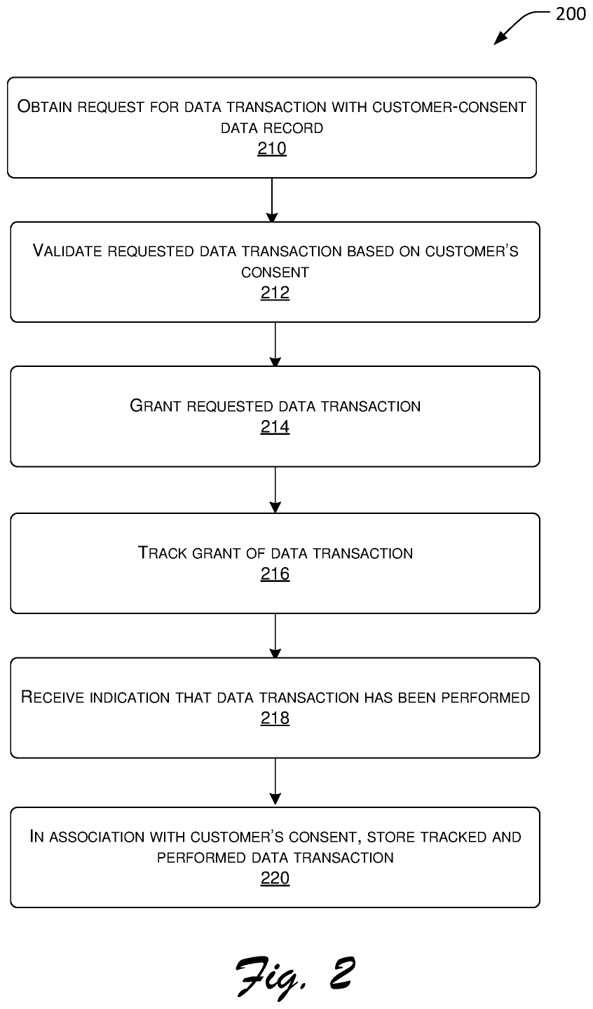

FIGS. 2-4 are flow diagrams illustrating example processes 200, 300, and 400 in accordance with the technologies described herein. The CM system 120 (or a portion thereof) of the example scenario 100 discussed above is an example of a system that is suitable implement the example processes 200, 300, and 400. For simplicity in discussion, the example process 200, 300, and 400 are described below as being performed by an example CM system. Of course, in other implementations, the example processes may be performed by a portion of the example CM system or a differently labeled or positioned system or component.

FIG. 2 illustrates the example process 200 which facilitates the tracking of consented data transactions with customer-consent data records by an agency.

At block 210, the example CM system obtains a request for a data transaction with the customer-consent data record. This request is from a requestor. The customer-consent data record is associated with a particular customer and one or more consent indications that indicate the permissible and/or impermissible usages of that customer-consent data record. The permissible and impermissible usages may be designated by the particular customer.

The customer-consent data record that is associated with the particular customer includes sensitive personal information (SPI) that can be used to identify, contact, or locate the particular customer.

Herein, a data transaction that is the subject of the request may be characterized as, for example, a use of and/or an action performed with or on the customer-consent data record. Regardless of the particular characterization, a data transaction with the customer-consent data record includes, for example, the following performed on, with, or in regard to the customer-consent data record: reading, copying, viewing, editing, analyzing, writing, modifying, accessing, sharing, accessing for advertising purposes, accessing for marketing purposes, accessing to facilitate generating a customized experience for the particular customer, accessing for product or service feedback or surveys, accessing for improving customer service, accessing to reduce risk of fraud, gathering metrics, and some combination thereof.

At block 212, the example CM system validates the requested data transaction based on the customer's consent. This is, the CM system determines whether the requested data transaction is permitted based on the one or more consent indications associated with the customer-consent data record. For example, if the request is to send emails to the customer about the latest sales promotion and the customer has consented to such, then the requestor is authorized to access to the customer's email address, and an email is subsequently sent.

However, if the example CM system determines that the customer has not consented to the requested data transaction, then the request is not validated, and the requestor cannot take any further action based on that request. In some instances, a denied or insufficient request may be documented in the audit log or, perhaps, another separate log.

At block 214, the example CM system grants the requested data transaction if the request is validated. That is, based on the validation of block 212, the example CM system grants the requested use of the customer-consent data record to the requestor.

At block 216, the example CM system tracks the grant of the data transaction. That is, the example CM system tracks the granted use of the customer-consent data record to the requestor. In some instances, it may do this by issuing a unique identifier with the grant that may be used to identify that particular grant thereafter.

At block 218, the example CM system receives an indication that the granted data transaction was performed by the requestor. That is, the example CM system receives an execution indication from the requestor that the requestor executed the granted use of the customer-consent data record in accordance with the consent indication that the validation is based. Often this execution indication is accompanied by the unique identifier of the grant.

At block 220, the example CM system stores a record of the tracked grant of and the indication of the performance of the data transaction. And it stores these items in association with the relevant consent of the customer. That is, it stores these items in association with the consent indication that the validation is based. In some instances, the example CM system may store—in association with the consent indication—a record of the requested use, tracked granted use, and/or the received execution indication in the audit log associated with the particular customer. In some other instances, the example CM system may store—in association with the consent indication that the validation is based—a record of the grant of the data transaction and/or a record of the received execution indication in the audit log associated with the particular customer.

Note that the example CM system is not modifying or tagging the customer-consent data record or its associated consent indications. Rather, the example CM system is keeping a separate record—in particular the audit log—for each customer that stores all tracked data transactions that occur relative to the customer-consent data record with its associated consent indications.

In addition, the example CM system maintains an index of the audit log to make searching of that log quick. Indeed, in some instances, the example CM system maintains an ongoing index of the audit log.

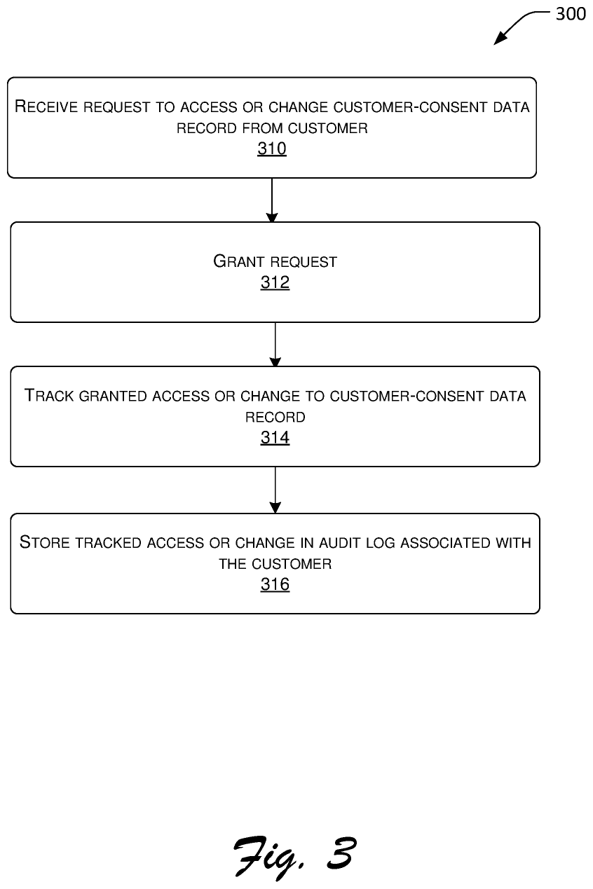

FIG. 3 illustrates the example process 300 which facilitates the transparency of the handling of the customers' SPI by allowing the customer to view and adjust their own information.

At block 310, the example CM system receives a request from the customer to access or change their own customer-consent data record. The customer may seek to view her SPI or the associated consents that the agency has possession of. If so, then the customer may seek access to the information or related consents. The customer may seek to change that information or the associated consents. If so, then the customer may seek to change that information or related consents.

At block 312, the example CM system grants the request once the identity of the customer is verified. Once the customer's identity is confirmed or the request is otherwise authorized, the example CM system grants the requested access or change of the customer-consent data record to the particular customer.

At block 314, the example CM system tracks the grant of the access or change to the customer-consent data record. This may be accomplished, at least in part, by the example CM system issuing a unique identifier that is associated with this particular grant.

At block 316, the example CM system stores the tracked grant and/or the actual access or change in the audit log that is associated with that customer.

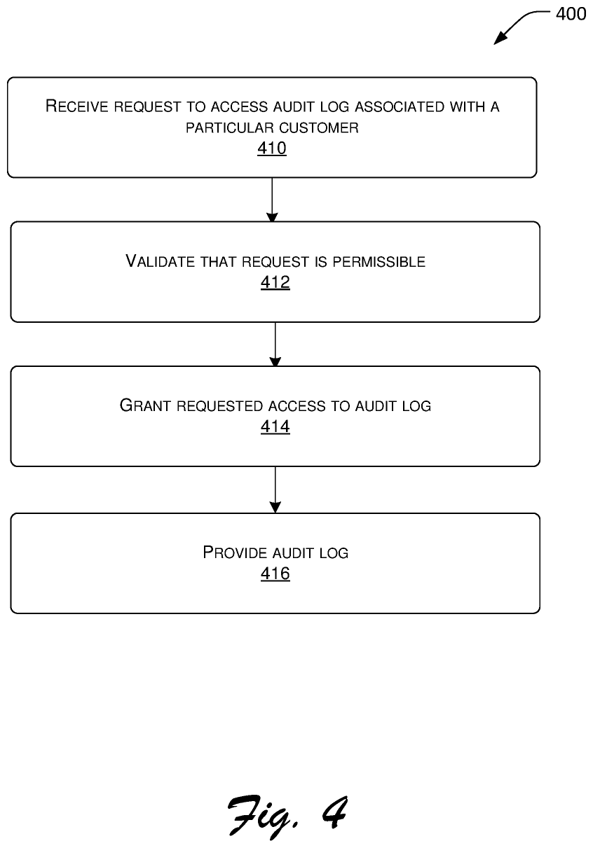

FIG. 4 illustrates the example process 400 which facilitates providing evidence of how the agency handles the SPI of customers.

At block 410, the example CM system receives a request from a requesting party to access the audit log associated with a particular customer. The requesting party may be, for example, the particular customer, an intragency compliance authority, the requestor, and/or an external third-party with proper authorization to view such records. The external third-party may be, for example, a government compliance officer, a court-appointed officer, or the like.

At block 412, the example CM system validates that the request is permitted and/or that the requesting party is permitted access to the audit log. Within the example CM system, particular requesting parties (like those discussed above) may be authorized to performed high-level tasks like examination of consent audit logs to confirm compliance with internal agency policies, compliance with governmental policies, and the like. The example CM system validates the request and/or the requestor when the combination is allowed or permitted based on specified permissions in the system itself or associated with the audit log.

At block 414, the example CM system grants the requested access based on the validation of the request and/or the requesting party. Like the approaches listed before, a unique identifier may be issued to track this particular grant.

At block 416, the example CM system provides the audit logs to the requesting party. For example, a copy of a portion of the audit log may be sent to the requesting party for viewing. In some instances, a record of this access to the audit log may be stored in the audit log itself.

In the above description of exemplary implementations, for purposes of explanation, specific numbers, materials configurations, and other details are set forth in order to better explain the present invention, as claimed. However, it will be apparent to one skilled in the art that the claimed invention may be practiced using different details than the exemplary ones described herein. In other instances, well-known features are omitted or simplified to clarify the description of the exemplary implementations.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

These processes are illustrated as a collection of blocks in a logical flow graph, which represents a sequence of operations that can be implemented in mechanics alone, with hardware, and/or with hardware in combination with firmware or software. In the context of software/firmware, the blocks represent instructions stored on one or more computer-readable storage media that, when executed by one or more processors, perform the recited operations.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

The term “machine-readable medium” is non-transitory machine-storage medium, computer-readable storage medium, computer-storage medium, machine-readable storage medium, or the like. For example, machine-readable medium may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

What is claimed is:

1. A non-transitory machine-readable storage medium encoded with instructions executable by a processor, the machine-readable storage medium comprising instructions to:
obtain a request from a requestor to use a customer-consent data record, wherein a consent indication indicates usages of the customer-consent data record that are designated permissible or impermissible and the customer-consent data record is associated with a particular customer;
validate that the requested use of the customer-consent data record is permissible based on the consent indication;
based on the validation, grant the requested use of the customer-consent data record to the requestor;
track the granted use of the customer-consent data record to the requestor;
receive an execution indication from the requestor that the requestor executed the granted use of the customer-consent data record in accordance with the consent indication that the validation is based;
in association with the consent indication, store a record of tracked granted use and the received execution indication in an audit log associated with the particular customer.

2. A non-transitory machine-readable storage medium as recited in claim 1, wherein the customer-consent data record associated with the particular customer includes sensitive personal information (SPI) that can be used to identify, contact, or locate the particular customer.

3. A non-transitory machine-readable storage medium as recited in claim 1, wherein the customer-consent data record associated with the particular customer includes information associated with the particular customer selected from a group consisting of full name, home address, mailing address, billing address, shipping address, email address, identification number, account identifier, passport number, driver's license number, Internet Protocol (IP) number, vehicle registration number, image of face, description of facial features, image of fingerprint, image of handwriting, image of signature, credit card numbers, bank account numbers, digital identity, date of birth, birthplace, genetic information, medical data, telephone number, login or username, gender, race, ethnicity, age, criminal record, online cookie information, web browsing history, place of residence, citizenship, legal status, marital status, social security number, religious preference, sexual orientation, security clearance, mother's maiden name, military records, disability information, biometrics, employment information and history, and some combination thereof.

4. A non-transitory machine-readable storage medium as recited in claim 1, wherein a requested use of the customer-consent data record includes actions performed on or with some portion of the customer-consent data record, the actions are selected from a group consisting of reading, copying, viewing, editing, analyzing, writing, modifying, accessing, sharing, accessing for advertising purposes, accessing for marketing purposes, accessing to facilitate generating a customized experience for the particular customer, accessing for product or service feedback or surveys, accessing for improving customer service, accessing to reduce risk of fraud, gathering metrics, and some combination thereof.

5. A non-transitory machine-readable storage medium as recited in claim 1, wherein the audit log is an indexed data record containing a history of actions taken that use the customer-consent data record based on usage grants.

6. A non-transitory machine-readable storage medium as recited in claim 1 further comprising instructions to:
receive a request from the particular customer to access or change the customer-consent data record associated with the particular customer;
grant the requested access or change of the customer-consent data record to the particular customer;
track the granted requested access or change of the customer-consent data record to the particular customer;
store the tracked access or change in the audit log associated with the particular customer.

7. A non-transitory machine-readable storage medium as recited in claim 1 further comprising instructions to:
receive a request from a requesting party to access the audit log associated with the particular customer;
validate that the requested access to the audit log is permissible by the requesting party;
grant the requested access to the audit log to the requesting party;
provide the audit log to the requesting party.

8. A non-transitory machine-readable storage medium as recited in claim 7, wherein the requesting party is the particular customer.

9. A method comprising:
obtaining a request from a requestor for a data transaction with a customer-consent data record, wherein a consent indication indicates usages of the customer-consent data record that are designated permissible or impermissible, and the customer-consent data record is associated with a particular customer;
validating that the requested data transaction is permissible based on the consent indication;
based on the validation, granting the requested data transaction to the requestor;
in association with the consent indication that the validation is based, storing a record of the grant of the data transaction in an audit log associated with the particular customer.

10. A method as recited in claim 9 further comprising:
receiving an execution indication from the requestor that the requestor executed the granted data transaction in accordance with the consent indication that the validation is based;
in association with the consent indication that the validation is based, storing a record of the received execution indication in the audit log.

11. A method as recited in claim 9 further comprising:
receiving a request from a requesting party to access the audit log associated with the particular customer;
validating that the requested access to the audit log is permissible by the requesting party;
grant the requested access to the audit log to the requesting party;
provide the audit log to the requesting party.

12. A non-transitory machine-readable storage medium encoded with instructions executable by a processor, the machine-readable storage medium comprising instructions to:
obtain a request from a requestor to perform a data transaction with a customer-consent data record, the customer-consent data record being associated with a particular customer and a consent indication that indicates permissible or impermissible usages of the customer-consent data record;
validate that the requested data transaction with the customer-consent data record is permissible based on the consent indication;
based on the validation, grant the requested data transaction with the customer-consent data record to the requestor;
track the granted data transaction with the customer-consent data record to the requestor;
in association with the consent indication, store a record of the granted data transaction in an audit log associated with the particular customer.

13. A non-transitory machine-readable storage medium as recited in claim 12, wherein the granted data transaction includes actions performed on or with the customer-consent data record.

14. A non-transitory machine-readable storage medium as recited in claim 12, wherein the granted data transaction is selected from a group consisting of reading, copying, viewing, editing, analyzing, writing, modifying, accessing, sharing, accessing for advertising purposes, accessing for marketing purposes, accessing to facilitate generating a customized experience for the particular customer, accessing for product or service feedback or surveys, accessing for improving customer service, accessing to reduce risk of fraud, gathering metrics, and some combination thereof.

15. A non-transitory machine-readable storage medium as recited in claim 12 further comprising instructions to:
receive a request from a requesting party to access the audit log associated with the particular customer;
validate that the requested access to the audit log is permissible by the requesting party;
grant the requested access to the audit log to the requesting party;
provide the audit log to the requesting party.
